(19) United States
(12) Patent Application Publication
(10) Pub. No.: US 2024/0329506 A1
(43) Pub. Date: Oct. 3, 2024

(54) LIGHT SOURCE SYSTEM

(71) Applicant: Appotronics Corporation Limited, Shenzhen (CN)

(72) Inventors: HONG-YUN CHEN, Shenzhen (CN); WEU-HUAN LUO, Shenzhen (CN)

(21) Appl. No.: 18/576,836

(22) PCT Filed: Jul. 14, 2022
(86) PCT No.: PCT/CN2022/105599

§ 371 Date: Jan. 5, 2024

(30) Foreign Application Priority Data
Jul. 30, 2021 (CN) 202110872659.6

(51) Int. Cl. G03B 21/20

(52) U.S. Cl. CPC G03B 21/2013; G03B 21/2033; G03B 21/2066; G03B 21/208

(57) ABSTRACT

A light source system includes a light source, a light splitting and combining assembly, a scattering assembly, and a light homogenizing element. The light source is configured for generating laser light which includes a first color light and a second color light. The light splitting and combining assembly is configured to combine the laser light to form a combined light beam. The scattering assembly is configured to scatter and homogenize the combined light beam. The scattering assembly includes a first scattering element and a second scattering element, and the first scattering element and the second scattering element are separately positioned. The light homogenizing element is located between the scattering assembly and the light splitting and combining assembly or behind the scattering assembly or between the first scattering element and the second scattering element.

### TECHNICAL FIELD

The present disclosure relates to the field of optics, and in particular, to a light source system.

### BACKGROUND

At present, with the continuous improvement of projection technology, people have significantly improved the viewing experience in terms of projection brightness, overcoming ambient light, and viewing angle range. In addition, projectors have extended their application environment from theaters to home due to their advantages, such as large display size and flexible projection position.

Due to the high brightness of laser diodes, with the maturity of laser diodes, laser diodes are gradually applied in the fields of projection and display. However, due to the serious speckle phenomenon of laser diodes, and the high requirements for projection and display on the display screen, the application of laser diodes in projection and display has been hindered. In order to realize the commercialization of laser diodes, a series of methods for eliminating speckle have emerged. Among them, one way to eliminate speckle is to add a speckle elimination device between the projection and the display screen. Although this method eliminates speckle, it will bring high cost and poor picture effect. Another way to eliminate speckle is to add a scattering sheet between a light source and a lens. However, in order to achieve the effect of eliminating speckles, the scattering sheet will cause a large amount of light to be reflected back in a direction toward the light source, resulting in a reduction in the amount of light output. If the same brightness needs to be achieved, more laser diodes need to be added, thus increasing a volume. In order to solve the above problems, the existing speckle elimination uses laser diodes and scattering sheets to correspond one to one, and a scattering sheet is placed in front of each laser diode, which invisibly increases the complexity of light source design.

### SUMMARY

In view of the above, the present disclosure provides a light source system, which includes a light source, a light splitting and combining assembly, a scattering assembly, and a light homogenizing element. The light source includes a plurality of laser diodes or a laser diode array and is configured for generating laser light, the laser light includes at least a first color light and a second color light, and the first color light and the second color light have different colors or different wavelengths. The light splitting and combining assembly is configured to combine the laser light to form a combined light beam. The scattering assembly is configured to scatter and homogenize the combined light beam. The scattering assembly includes a first scattering element and a second scattering element, and the first scattering element and the second scattering element are separately positioned. The light homogenizing element is located between the scattering assembly and the light splitting and combining assembly or behind the scattering assembly or between the first scattering element and the second scattering element and is configured for homogenizing light beam incident to the light homogenizing element.

In the present disclosure, two scattering elements are disposed in an optical path of the laser diode array or the plurality of laser diodes, so that the two scattering elements simultaneously scatter multi-color laser light. On the one hand, it achieves the effect of eliminating speckles while ensuring the light efficiency. On the other hand, compared with providing a scattering element for each laser diode, the combined light beam is scattered in the present disclosure, which can reduce the volume of the light source system.

### BRIEF DESCRIPTION OF THE DRAWINGS

In order to more clearly illustrate technical solutions of embodiments of the present disclosure, the accompanying drawings used in the embodiments are briefly described below. Obviously, the drawings described below are merely a part of the embodiments of the present disclosure. Based on these drawings, those skilled in the art can obtain other drawings without any creative effort.

FIG. 1 is a schematic diagram of a light source system according to an embodiment of the present disclosure.

FIG. 2 is a schematic diagram of a light source system according to another embodiment of the present disclosure.

FIG. 3 is a schematic diagram of a light source system according to yet another embodiment of the present disclosure.

FIG. 4 is a schematic diagram of a light source system according to yet another embodiment of the present disclosure.

FIG. 5 is a schematic diagram of a light source system according to yet another embodiment of the present disclosure.

### DETAILED DESCRIPTION

The technical solutions in the embodiments of the present disclosure are clearly and completely described below with reference to the accompanying drawings in the embodiments of the present disclosure. The described embodiments are merely some rather than all of the embodiments of this disclosure. All other embodiments obtained by those of ordinary skill in the art based on the embodiments of the present disclosure without creative efforts are to fall within the protection scope of the present disclosure.

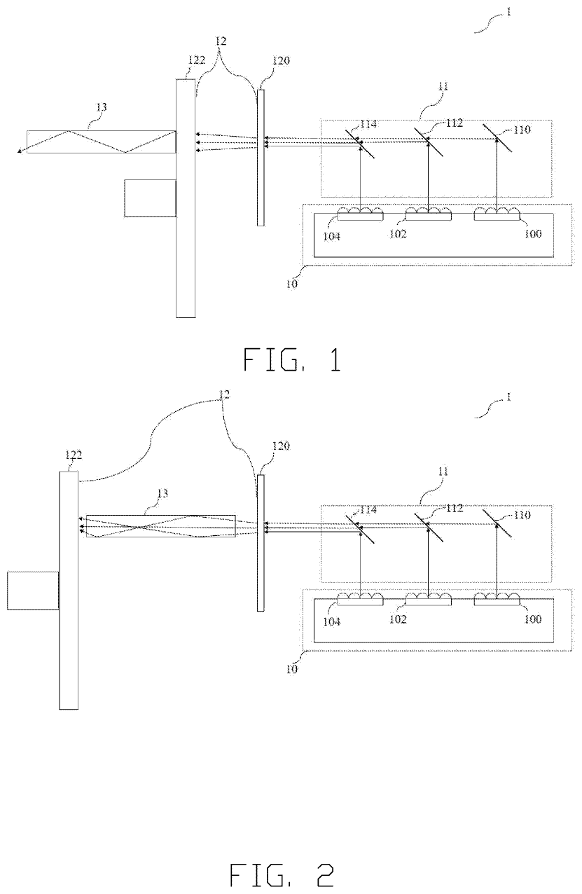

According to some embodiments of the present disclosure, as illustrated in FIGS. 1 to 3, a light source system 1 is disclosed. The light source system 1 includes a light source 10, a light splitting and combining assembly 11, a scattering assembly 12, and a light homogenizing element 13. The light source 1 includes a plurality of laser diodes or a laser diode array and is configured for generating laser light, the laser light includes at least a first color light and a second color light, and the first color light and the second color light have different colors or different wavelengths. The colors refer to red, green, blue, yellow, orange and other colors that can be distinguished by conventional vision. The wavelengths refer to specific wavelength ranges or dominant wavelengths.

The light splitting and combining component 11 is configured to combine the laser light to form a combined light beam. The scattering assembly 12 is configured to scatter and homogenize the combined light beam. The scattering assembly 12 includes a first scattering element 120 and a second scattering element 122, and the first scattering element 120 and the second scattering element 122 are separately positioned. The light homogenizing element 13 is configured for homogenizing light beam incident to the light homogenizing element 13.

In the embodiment illustrated in FIG. 1, the light homogenizing element 13 is located behind the scattering assembly 12. Specifically, the combined light beam is incident to the scattering assembly 12, and then passes through the scattering assembly 12. A propagation direction of the light scattered by the scattering assembly 12 changes, thereby breaking up superposition phenomenon of peaks or troughs in the process of light propagation, eliminating the coherence of the laser light, and realizing speckle elimination. The light beam passes through the scattering assembly 12 and then is incident to the light homogenizing element 13 for homogenizing. In the embodiment, the laser beam is first incident to the scattering component 12 and then is incident to the light homogenizing element 13, achieving a better light homogenizing effect. The laser beam has been homogenized once passing through the scattering assembly, and then passes through the light homogenizing element to achieve a better light homogenizing effect.

In the embodiment illustrated in FIG. 2, the light homogenizing element 13 is located between the first scattering element 120 and the second scattering element 122 of the scattering assembly 12. The combined light beam is incident to the first scattering element 120, and the propagation direction of the light passing through and scattered by the first scattering element 120 changes, thereby breaking up the superposition phenomenon of peaks or troughs in the process of light propagation, eliminating the coherence of laser light, and achieving speckle elimination. The light beam passes through the first scattering element 120, and then is incident to the light homogenizing element 13 for homogenizing. The light beam being homogenized is incident to the second scattering element 122, and the propagation direction of the light passing through and scattered by the second scattering element 122 changes, thereby further eliminating the coherence of the laser light. In the embodiment, the laser beam is first scattered by the first scattering element 120, then homogenized by the light homogenizing element 13, and finally scattered by the second scattering element 122, achieving a better light homogenizing effect and speckle elimination effect.

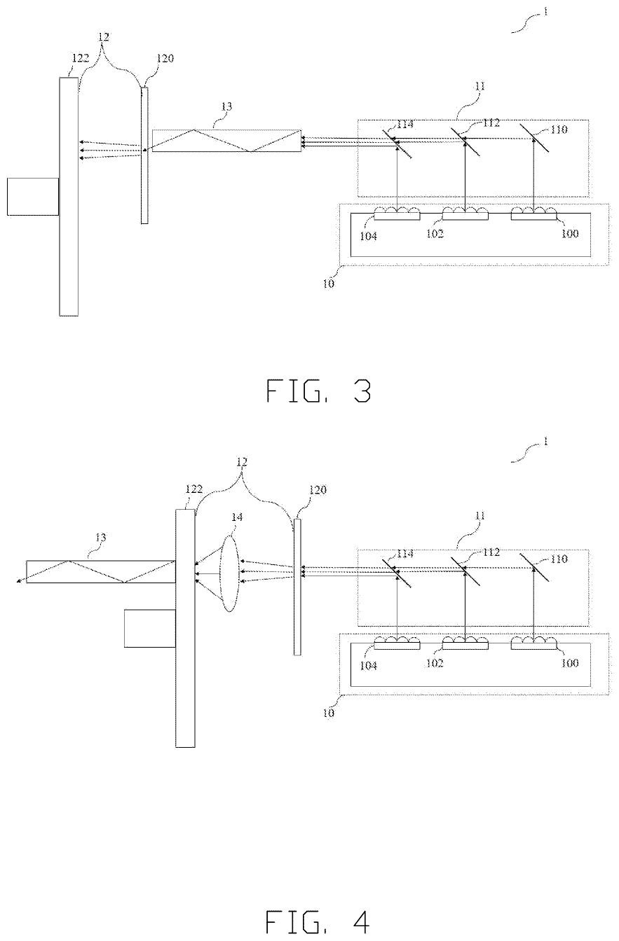

In the embodiment illustrated in FIG. 3, the light homogenizing element 13 is located between the scattering assembly 12 and the light splitting and combining assembly 12. Specifically, the combined light beam is incident to the light homogenizing element 13 for homogenizing. The light beam being homogenized is incident to the scattering assembly 12, and the propagation direction of the light passing through and scattered by the scattering assembly 12 changes, thereby breaking up the superposition phenomenon of peaks or troughs in the process of light propagation, eliminating the coherence of the laser light, and preventing from generating speckle.

It should be noted that the first scattering element 120 and the second scattering element 122 are separately positioned, which means that the first scattering element 120 and the second scattering element 122 are not integrally and continuously arranged from the same material. For example, an air gap is disposed between the first scattering element 120 and the second scattering element 122, or an optical element is disposed between the first scattering element 120 and the second scattering element 122. In some embodiments, the optical element is, for example, a lens, a third scattering element whose scattering property is weaker than that of the first scattering element 120 and the second scattering element 122, or the like. In the present disclosure, two independently arranged scattering elements are provided, by arranging a thickness of each scattering element, it is possible to make a thickness of the two scattering elements equal to a thickness of one traditional scattering element, so that most of light that passes through and is scattered by the first scattering element will transmit along an optical path without being reflected back to the light source to cause loss. When the light passing through the first scattering element passes through the second scattering element, most of the light passing through the second scattering element will be emitted. Compared with providing a scattering element with a thicker thickness, it can emit more light while having a better scattering effect, thereby improving the light efficiency.

In addition, it should be noted that there are many ways to arrange the plurality of laser diodes. The plurality of laser diodes can be arranged as a row of laser diodes, or as an L-shaped arrangement of laser diodes. The L-shaped arrangement of laser diodes can emit parallel beams or non-parallel beams by designing the optical path.

In the above embodiments, two scattering elements are disposed on the optical path of the laser diode array or the plurality of laser diodes to scatter the multi-color laser light. By controlling the positions or thicknesses of the two scattering elements, the two scattering elements can simultaneously scatter the multi-color laser light. On the one hand, the speckle elimination effect can be achieved while ensuring the light efficiency. On the other hand, compared with providing a scattering element for each laser diode, the combined light beam is scattered in the present disclosure, which can reduce the volume of the light source system. Compared with a prior art of providing a scattering element for each laser diode, in the above embodiment, the scattering element is disposed downstream of the optical path of the combined light beam, thereby reducing the volume of the device. In addition, light with different wavelengths has different scattering intensities, the scattering element needs to reach a certain thickness to achieve speckle elimination, for example, the thickness is greater than 1 cm. When a scattering thickness of the scattering element (e.g., a transmissive type) is too large, a part of the incident light beam cannot reach an outgoing side of the scattering element, but escapes from an incidence side of the scattering element, resulting in optical loss. In the present disclosure, the first scattering element 120 and the second scattering element 122 are separately positioned, on the premise of satisfying the scattering thickness, the optical loss of the light beam incident to the first scattering element 120 is reduced, and the optical loss of the light which is emitted by first scattering element 120 and is incident to the second scattering element is also reduced. The light beam has not been scattered in the gap between the first scattering element 120 and the second scattering element 122, or there are fewer scattering particles in the gap between the first scattering element 120 and the second scattering element 122. So that compared with a single scattering element with a thickness same as a total thickness of the first scattering element 120 and the second scattering element 122, the first scattering element 110 and the second scattering element 112 which are separately positioned can reduce light escaping from the incidence side of the scattering element, thereby reducing optical loss.

In the embodiment illustrated in FIG. 4, the light source system 1 further includes a light condensing element 14 for converging the combined light beam. In the embodiment illustrated in FIG. 4, the light condensing element 14 is located between the first scattering element 120 and the second scattering element 122. Those skilled in the art know that the condensing element 14 conventionally uses a condensing lens, a convex lens, a concave-convex mirror, or a combination thereof to achieve the function of converging or collimating light.

In the above embodiments, outgoing directions of the light beam scattered by and passing through the first scattering element 120 are relatively divergent, and the light beam is converged by the light condensing element 14, so that as many light beams as possible emit from the first scattering element 120 and then is incident to the second scattering element 122, thereby further reducing optical loss. In some embodiments, a light-output focus of the light condensing element 14 falls into a scattering area of the second scattering element 120.

In other embodiments, the light condensing element 14 is located between the light homogenizing element 13 and the second scattering element 122, or between the light splitting and combining assembly 11 and the first scattering element 120.

In some embodiments, the light homogenizing element 13 is a square rod. Alternatively, the light homogenizing element 13 is a fly-eye.

In some embodiments, the scattering area of the second scattering element 122 is larger than a scattering area of the first scattering element 120, so that the light beam emitted by the first scattering element 120 can fall into the second scattering element 122 even though outgoing directions of the light beam emitted by first scattering element 120 are divergent.

In some embodiments, both the first scattering element 120 and the second scattering element 122 are transmissive scattering elements. In some alternative embodiments, at least one of the first scattering element 120 and the second scattering element 122 is a reflective scattering element.

In some embodiments, the first scattering element 120 includes a scattering layer made of scattering materials.

In some embodiments, the first scattering element 120 includes a scattering layer made of scattering materials, the scattering layer includes white scattering particles, and the white scattering particles include at least one of titanium dioxide and aluminum dioxide.

In some embodiments, the second scattering element 122 is movable relative to the light source. During the movement of the second scattering element 122, when the combined light beam is incident to the second scattering element 122, it will be incident to different regions of the second scattering element 122, and there may or may not be an overlapping region between the different regions. In addition, at least a portion of the different regions are scattering regions. It should be noted that the “scattering region” mentioned in the text refers to a region where a scattering medium is distributed and can scatter an incident light beam. By moving the second scattering element 122, the scattering region where the light beam is scattered will change, so that a certain region will not be in a working state all the time, thereby avoiding local overheating of the second scattering element 122.

In some alternative embodiments, both the first scattering element 120 and the second scattering element 122 are fixed scattering elements. In other alternative embodiments, both the first scattering element 120 and the second scattering element 122 are movable relative to the light source. In the embodiment illustrated in FIGS. 1 to 5, the first scattering element 120 is a fixed scattering element, and the second scattering element 122 is movable relative to the light source.

In some embodiments, the second scattering element 122 includes a transmissive substrate and a scattering material layer, and the scattering material layer is disposed on the transmissive substrate. For example, the scattering material layer is disposed on an incidence side or an outgoing side of the transmissive substrate. In other words, the scattering material layer is disposed on a side of the transmissive substrate facing the combined light beam or a side of the transmissive substrate facing away from the combined light beam. The scattering material layer can also be disposed inside the transmissive substrate. A material of the scattering material layer may be scattering powder or glue, such as silica gel. In addition, the transmissive substrate includes a polymer material sheet, such as a PC (Polycarbonate, polycarbonate) sheet or an acrylic sheet. However, the above materials are only exemplary, and do not constitute a limitation to the protection scope of the present disclosure.

In some embodiments, the second scattering element 122 which is movable relative to the light source moves around an axis, and the light beams incident to the second scattering element 122 is distributed on the second scattering element 122 around the axis. Without limitation, the transmissive substrate is provided with a rotation shaft that rotates around the axis, and the second scattering element 122 is driven by the rotation shaft to rotate around the axis. In some embodiments, the second scattering element 122 that is movable relative to the light source reciprocates in the direction of the optical axis, and during the reciprocating movement, the region of the second scattering element 122 receiving laser light from the light source also changes accordingly. Regardless of whether the second scattering element 122 moves around the axis or moves relative to the light source in the direction of the optical axis of the laser light from the light source, the scattering material layer may only be disposed at a region where the laser light is incident to the second scattering element 122.

In the above embodiments, when the scattering materials are of standard distribution, material and density, a thickness of the scattering materials required for achieving laser scattering is a standard scattering thickness, an equivalent thickness of the scattering layer of the first scattering element 120 and an equivalent thickness of the scattering material layer of the second scattering element 122 are both less than the standard scattering thickness, and a sum of the equivalent thickness of the scattering layer of the first scattering element 120 and the equivalent thickness of the scattering material layer of the second scattering element 122 is not less than the standard scattering thickness. It should be noted that an equivalent thickness represents a thickness of the scattering materials with standard distribution, material and density required to achieve the same scattering effect. For example, for scattering materials A with standard distribution, material and density, the scattering thickness required for achieving effective laser scattering is P, and for scattering materials B with non-standard distribution, material and density and a thickness of Q, the standard thickness is Q′. The scattering effect of the scattering materials A with standard distribution, material and density and a thickness of Q′ is the same as the scattering effect of scattering materials B with non-standard distribution, material and density and a thickness of Q. When the scattering materials B are scattering materials with standard distribution, material and density, Q is equal to Q′. It should be noted that the “standard distribution, material and density” may be any combination of distribution, material and density.

In some embodiments, a thickness of the scattering material layer of the first scattering element 120 is equal to or less than 1 cm. When the thickness of the scattering layer is equal to or less than 1 cm, at least a part of the light beam incident to the first scattering element 120 can emit from the outgoing side of the first scattering element 120. Preferably, the thickness of the scattering material layer is less than or equal to 0.5 cm. More preferably, the thickness of the scattering material layer is less than or equal to 0.2 cm, which can achieve more light beams emitted by the first scattering element 120. Furthermore, the thickness of the scattering material layer is less than or equal to 0.1 cm.

In some embodiments, a thickness of the scattering material layer of the second scattering element 122 is less than or equal to 1 cm. When the thickness of the scattering material layer is less than or equal to 1 cm, at least part of the light beam incident to the second scattering element 122 can emit from the outgoing side of the second scattering element 122. Preferably, the thickness of the scattering material layer is less than or equal to 0.5 cm. More preferably, the thickness of the scattering material layer is less than or equal to 0.2 cm, which can achieve more light beams emitted by the second scattering element 122. Furthermore, the thickness of the scattering material layer is less than or equal to 0.1 cm.

It is worth explaining that, in the present disclosure, two scattering elements are separately positioned, and a focusing lens and other components are disposed between the two scattering elements. After light passes through the first scattering element, the scattered light is converged through the focusing lens and then is incident to the second scattering element, which can ensure that the light lost because of scattering is the least. At the same time, by controlling the thickness of the scattering sheet, the outgoing light can not only eliminate the speckles, but also minimize the loss of light.

The light source 10 of the present disclosure may include a laser diode array, and the laser diode array includes at least one of a red laser diode, a green laser diode, and a blue laser diode. The laser diode array generates laser light, and the laser light may include laser light of first color, laser light of second color, and laser light of third color. More preferably, the laser diode array includes laser diodes of at least two colors of red laser diodes, green laser diodes, and blue laser diodes.

The light source 10 of the present disclosure may further include a first light source 100, a second light source 102, and a third light source 104. The first light source 100 can be a plurality of red laser diodes, a plurality of green laser diodes, a plurality of blue laser diodes, or a plurality of yellow laser diodes, which emit laser light of first color. Similarly, the second light source 102, the third light source 104 each can also be a plurality of red laser diodes, a plurality of green laser diodes, a plurality of blue laser diodes, or a plurality of yellow laser diodes, which respectively emit laser light of second color and laser light of third color.

The above laser light includes a first color light, a second color light, and a third color light, and the wavelengths or main wavelengths of the three kinds of light are different. For example, they may be red light, green light, and blue light.

The light splitting and combining assembly 11 also includes a reflecting element 110, a first splitting and combining element 112, and a second splitting and combining element 114. The first color light is reflected by the reflecting element 110, and then passes through the first light splitting and combining element 112 and the second light splitting and combining element 114 to form outgoing light of first color. The second color light is reflected by the first light splitting and combining element 112 and then passes through the second light splitting and combining element 114 to form outgoing light of second color. The third color light is reflected by the second light splitting and combining element 114 to form outgoing light of third color. The outgoing light of first color, the outgoing light of second color, and the outgoing light of third color form the combined light beam.

Specifically, the reflecting element 110 has the property of reflecting the first color light. The first light splitting and combining element 112 has the property of transmitting the first color light and reflecting the second color light. The second light splitting and combining element 114 has the property of transmitting the first color light and the second color light and reflecting the third color light.

Because of structures of the first light source 100, the second light source 102, and the third light source 104, the overall width of a beam of first color light, a beam of second color light, and a beam of third color light respectively emitted by the first light source 100, the second light source 102, and the third light source 104 cannot be arranged too narrow. For example, when the overall width of the first light source 100, the second light source 102, and the third light source 104 is x, and the light emitted by the three light sources are parallel to each other, the maximum distance between the optical axes of the first color light, the second color light, and the third color light will not be smaller than x. Since the beam has a certain width, the width of the overall beam must be greater than x. The reflecting element 110, the first light splitting and combining element 112, and the second light splitting and combining element 114 are arranged to narrow the overall width of the first color light, the second color light, and the third color light, which can also be seen from FIGS. 1 to 5.

In some embodiments, directions of the first color light, the second color light, and the third color light are the same, directions of the outgoing light of first color, the outgoing light of second color, and the outgoing light of third color are the same, and the maximum distance between the optical axis of the outgoing light of first color, the optical axis of the outgoing light of second color, and the optical axis of the outgoing light of third color on a plane perpendicular to the outgoing light of first color is smaller than the maximum distance between the first light source, the second light source, and the third light source on a plane perpendicular to the first color light.

However, in other embodiments, the directions of the first color light, the second color light, and the third color light may also be different from each other. For example, the first color light, the second color light, and the third color light each may be incident to a enter collimator, then light emitted from the collimator is incident to the reflecting element 110, the first light splitting and combining element 112, and the second light splitting and combining element 114. Similarly, the directions of the outgoing light of first color, the outgoing light of second color, and the outgoing light of third color can also be different from each other. For example, the outgoing light of first color, the outgoing light of second color, and the outgoing light of third color each is incident to a collimator to achieve the parallel effect.

In some embodiments, the optical axis of the outgoing light of first color, the optical axis of the outgoing light of second color, and the optical axis of the outgoing light of third color coincide with each other. In other words, the point where the first color light is transmitted to the first light splitting and combining element 112 coincides with the point where the second color light is incident to the first splitting and combining element 112, the point where the first color light and the second color light is transmitted to the second light splitting and combining element 114 coincides with the point where the third color light is incident to the second light splitting and combining element 114. When the optical axis of the outgoing light of first color, the optical axis of the outgoing light of second color, and the optical axis of the outgoing light of third color coincide with each other, the outgoing light of first color, a width of a beam of the combined light formed by the outgoing light of first color, the outgoing light of second color, and the outgoing light of third color is the narrowest.

In some embodiments, the first light combining and splitting element 112 transmits blue light and reflects green light, and the second light combining and splitting element 114 transmits blue light and green light and reflects red light. Correspondingly, the first light source 100 is a blue laser light source, the second light source 102 is a green laser light source, and the third light source 104 is a red laser light source.

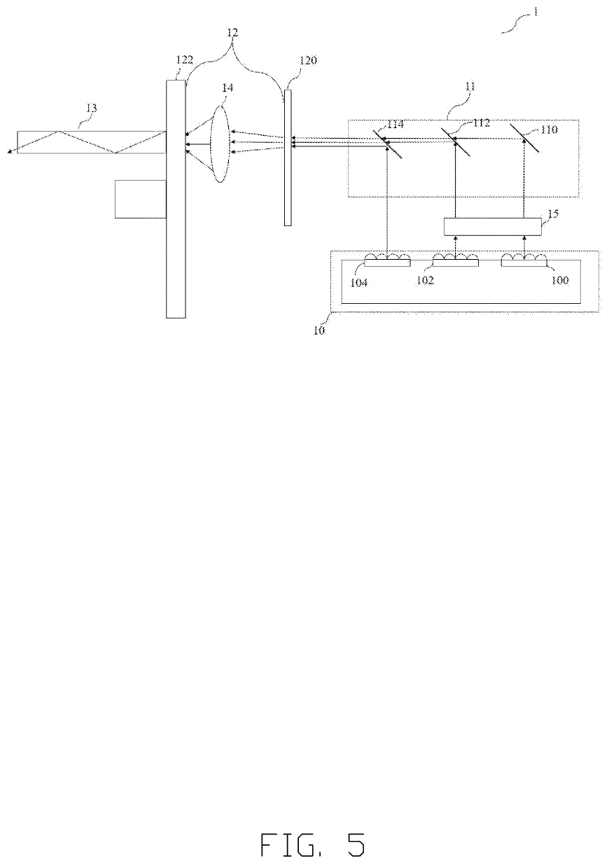

In the embodiment illustrated in FIG. 5, the light source system 1 further includes a half wave plate 15. The half wave plate 15 is disposed on the outgoing side of at least one laser diode. The half wave plate 15 is arranged to change the polarization direction of the outgoing light, so that the light splitting and combining component 11 can transmit the light in the first polarization direction and reflect the light in the second polarization direction.

In some embodiments, the reflecting element 110, the first light splitting and combining element 112, and the second light splitting and combining element 114 are at an angle of 45 degrees with respect to the light emitting direction of the first light source 100. In some embodiments, the first light source 100, the second light source 102, and the third light source 104 are parallel to each other. Therefore, the reflecting element 110, the first light splitting and combining element 112, and the second light splitting and combining element 114 are at an angle of 45 degrees with respect to the light emitting direction of the second light source 102 and the third light source 104.

The above are only embodiments of the present disclosure which do not limit the patent scope of the present disclosure, and any equivalent structure or equivalent process made based on the description and drawings of the present disclosure, or those directly or indirectly applied in other related technical fields, are all included in the scope of patent protection of the present disclosure.

1. A light source system, comprising:
a light source comprising a plurality of laser diodes or a laser diode array and configured for generating laser light, the laser light comprising a first color light and a second color light, the first color light and the second color light having different colors or different wavelengths;
a light splitting and combining assembly configured to combine the laser light to form a combined light beam;
a scattering assembly configured to scatter and homogenize the combined light beam, the scattering assembly comprising a first scattering element and a second scattering element, the first scattering element and the second scattering element being separately positioned; and
a light homogenizing element located between the scattering assembly and the light splitting and combining assembly, or located behind the scattering assembly, or located between the first scattering element and the second scattering element, the light homogenizing element being configured for homogenizing light beam incident to the light homogenizing element.

2. The light source system according to claim 1, further comprising a light condensing element configured for converging the combined light beam, wherein the light condensing element is located between the first scattering element and the second scattering element.

3. The light source system according to claim 1, wherein the first scattering element comprises a scattering layer made of scattering materials, a thickness of the scattering layer is less than or equal to 1 cm.

4. The light source system according to claim 1, wherein the first scattering element comprises a scattering layer made of scattering materials, the scattering layer comprises white scattering particles, a thickness of the scattering layer is less than or equal to 0.2 cm.

5. The light source system according to claim 1, wherein the second scattering element is movable relative to the light source.

6. The light source system according to claim 5, wherein the second scattering element comprises a transmissive substrate and a scattering material layer, the scattering material layer is disposed on the transmissive substrate.

7. The light source system according to claim 5, wherein the second scattering element is configured to move around an axis or reciprocate in a direction of an optical axis.

8. The light source system according to claim 1, wherein the light source is the laser diode array, the laser diode array comprises at least two of a red laser diode, a green laser diode, and a blue laser diode.

9. The light source according to claim 1, wherein the laser light further comprises a third color light,
the light splitting and combining assembly further comprises a reflecting element, a first splitting and combining element, and a second splitting and combining element,
the first color light is reflected by the reflecting element and passes through the first light splitting and combining element and the second light splitting and combining element to form outgoing light of first color, the second color light is reflected by the first light splitting and combining element and passes through the second light splitting and combining element to form outgoing light of second color, the third color light is reflected by the second light splitting and combining element to form outgoing light of third color, the outgoing light of first color, the outgoing light of second color, and the outgoing light of third color form the combined light beam.

10. The light source system according to claim 9, wherein an optical axis of the outgoing light of first color, an optical axis of the outgoing light of second color, and an optical axis of the outgoing light of third color coincide with each other.

11. The light source system according to claim 9, wherein the first light splitting and combining element is configured to transmit blue light and reflect green light, the second light splitting and combining element is configured to transmit blue light and green light and reflect red light.

12. The light source according to claim 1, wherein the light source comprises a half wave sheet, the half wave sheet is disposed on an outgoing side of at least one laser diode.

13. The light source system according to claim 1, wherein each of the first scattering element and the second scattering element is fixed with respect to the light source.

14. The light source system according to claim 1, wherein each of the first scattering element and the second scattering element is movable with respect to the light source.

15. The light source system according to claim 1, wherein the first scattering element is fixed with respect to the light source, and the second scattering element is movable with respect to the light source.
